(19) United States
(12) Patent Application Publication
(10) Pub. No.: US 2025/0215578 A1
(43) Pub. Date: Jul. 3, 2025

(54) METHOD OF ELECTRODEPOSITION IN SEAWATER FOR THE GROWTH OF CONSTRUCTION MATERIALS

(71) Applicants: CEMEX Innovation Holding AG, Zug (CH); Northwestern University, Evanston, IL (US)

(72) Inventors: Alessandro ROTTA LORIA, Evanston, IL (US); Jeffrey LOPEZ, Evanston, IL (US); Nishu DEVI, Evanston, IL (US); Amy WAGNER, Evanston, IL (US); Alexandre GUERINI, Lyss (CH); Davide ZAMPINI, Zug (CH)

(21) Appl. No.: 18/400,950

(22) Filed: Dec. 29, 2023

(51) Int. Cl. C25B 1/18; C25B 15/08

(52) U.S. Cl. CPC C25B 1/18; C25B 15/08

(57) ABSTRACT

The present invention relates to a method to produce calcium rich-based aggregates by electrodeposition in salty aqueous CO₂ enriched solutions, that can be used in the construction industry. The method includes filtering an aqueous salty solution to produce an aqueous salty solution free of organic debris or pollutants, adjusting a temperature and pH in a conditioning reactor CR1 to produce an aqueous salty solution, bringing the aqueous salty solution from CR1 to a continuous reactor CR2 equipped with an electroactive substrate comprising at least one cathode and at least one anode connected to an electrical DC supply, injecting in CR2 a flux of a gas mixture containing CO₂ (C-gas) in contact with the flux of the aqueous solution, applying to the flux of the CO₂-enriched aqueous solution a constant DC current, and recovering the calcium rich-based aggregates deposited on the electroactive substrate and/or on the bottom of CR2.

### TECHNICAL FIELD OF THE INVENTION

Climate change is one of the most pressing challenges facing the world today. It is caused by the release of greenhouse gases into the atmosphere, which trap heat and warm the planet. Process industries, such as chemicals, cement, metallurgy, and refining, are among the largest emitters of greenhouse gases. For example, cement production alone is responsible for about 8% of global CO₂ emissions.

Decarbonizing the cement sector requires creating transformative pathways to reduce carbon emissions associated with cement and concrete manufacturing. In this context, the sustainable sourcing of calcium- and magnesium-based minerals represents a paramount priority due to their dominant use in more sustainable cements and presence as aggregates in concrete, respectively, but also as source of raw material for the cement manufacturing or additions to be used in cements as part of the overall binder. In response to this challenge, the current study demonstrates an innovative electrochemical mineral precipitation approach that offers a carbon-negative solution for the selective and tailorable growth of calcium- and magnesium-based minerals from ocean and sea waters via electrodeposition.

### STATE OF THE ART

It is known that CO₂ contained or added to sea water can lead to the precipitation of minerals using electrochemical methods. In fact, the methods available in the literature have as a primary objective the precipitation of minerals, without caring for the type, typology, and overall characteristics of the precipitated minerals.

For example, U.S. Pat. No. 11,413,578 [1] provides a method to remove CO₂ from an aqueous stream, wherein an aqueous solution comprising CO₂ and ions capable of forming an insoluble carbonate salt contacts an electroactive mesh, forcing the precipitation of carbonate solid(s) from the solution. With the focus on carbon sequestration, the method does not detail a process to produce materials specific to the construction industry, with customizable sizes and densities. Furthermore, the method does not teach how to control the different process parameters, such as pH, applied voltage, or temperature, to produce said customized materials, like the present invention does.

Another example would be WO 2022/178125 [2], disclosing a system, comprising: a fluid container; an electrode pair configured to convert the contained fluid to a solid; and a nanotextured surface configured to facilitate nucleation of the solid within the container. Like U.S. Pat. No. 11,413,578 [1], a surface is needed for the electrodeposition of the solids; furthermore, no details regarding the control of the process to produce specific particles are mentioned.

Other similar examples, also purely focusing on carbon sequestration, would be WO 2007/140544, US20100084283, EP 1 830 945 or U.S. Pat. No. 11,465,925 [3-6], whereby the formation of carbonate products is done in multiple steps, and/or using a different method than the one hereby disclosed, and never targeting the production of customizable construction materials, with specific sizes or densities.

Another application of CO₂ mineralization is sea life and coral restoration. Examples of such applications include Zhang et al. (Direct Electrochemical Seawater Splitting for Green Hydrogen and Artificial Reefs, ACS Applied Energy Materials. 6 (14): 7636-7642, 2023) [7], or Carré et al. (Electrochemical calcareous deposition in seawater. A review, Environmental Chemistry Letters, 18:1193-1208, 2020) [8]. Despite similar electrochemical methods are used, the application, and consequently the desired properties of the final obtained materials, are significantly different.

Nonetheless, to use said minerals in cement production, it is beneficial to be able to predict and even control their characteristics, to ensure that the precipitated material can be used as fine aggregate, and the final product still complies with the existing norms and standards.

The prior art does not describe any detailed method for the purpose of precipitation specifically targeted minerals from the sea water to be used in the cement industry as raw material or additions to cements, or as aggregates in concrete mix designs.

### DESCRIPTION OF THE INVENTION

Problem to solve: About 13 billion tons of sand are used annually just for construction, as the second most-used resource on Earth, and this demand is growing by about half a ton per year, expected to reach 20 billion tons annually by 2030. Due to the monumental demand for sand from the construction industry, the world is inching towards a crisis of sand depletion. Highly desirable sand from rivers and lakes is not an endless resource and already the construction industry suffers from a lack of it.

The current invention proposes a method/process and an equipment/device to mitigate the scarcity of sand (to be used in the cement and concrete industry) by using a combination of available CO₂ and sea water (that contains high amounts of dissolved ions) and electrodeposition technology. Conditions are defined to favor the precipitation of selective minerals to meet the requirements of the construction industry.

This invention relates to a novel concept of electrodeposition in seawater that underpins the growth of construction materials for use in the cement and concrete industries and has the extra benefit of absorbing CO₂ from the atmosphere. The overarching principle behind such a carbon-negative manufacturing approach specifically lies in injecting CO₂ gas while applying an electric current in ocean and sea waters, as solely done to trigger the classical electrodeposition process. The injection of CO₂ in sea and ocean waters boosts the electrodeposition of minerals at cathodic interfaces, making such an approach adequate to serve the cement and concrete industries. The invention according to the patent is that electrodeposits form in ocean and sea waters by the reaction between hydroxide ions resulting from oxygen reduction reaction and/or water electrolysis, abundant divalent ions (e.g., magnesium and calcium) in ocean and sea waters, and bicarbonate ions naturally dissolved therein. The injection of CO₂ gas increases the concentration of bicarbonate ions, accelerating the growth rate of deposited minerals on the cathode surface by establishing a synergistic balance between injected CO₂ and applied electrochemical potential.

The invention thus relates to a method/process and an equipment/device to produce calcium rich-based aggregates by electrodeposition in salty aqueous CO₂ enriched solutions, that can be used in the construction industry.

An objective of the present invention is therefore a method to produce calcium rich-based aggregates, said method comprising the following steps:
a) Filter an aqueous salty solution AS1 to produce an aqueous salty solution AS2 free of organic debris or pollutants;
b) Bring the aqueous salty solution AS2 at a temperature from 18 to 29° C. and at a pH from 7.1 to 9, in a conditioning reactor CR1 to produce an aqueous salty solution AS3;
c) Bring the aqueous salty solution AS3 from CR1 to a continuous reactor CR2 equipped with an electroactive substrate comprising at least one cathode and at least one anode connected to an electrical DC supply, wherein the flux of AS3 (FRAS3) in CR2 is kept at a velocity or displacement speed VAS3 located from 0.01 m/s to 5 m/s;
d) Inject in CR2 a flux of a gas mixture containing CO₂ (C-gas) in contact with the flux of the aqueous solution AS3;
e) Apply to the flux of the CO₂-enriched aqueous solution AS3 a constant DC current ranging from 1 A/m² to 5000 A/m², the m² representing the deployed surface of the electrodes in contact with AS3, or a voltage ranging from 0.5 V to 20.0 V, to the electrodes;
f) Recover the calcium rich-based aggregates deposited on the electroactive substrate and/or on the bottom of CR2.

According to a particular embodiment of the method of the present invention, the aqueous salty solution AS2 is brought in step b) at a temperature from 20° C. to 25° C. and at a pH from 8.0 to 8.4, in CR1.

According to a particular embodiment of the method of the present invention, the continuous reactor CR2 of step c) comprises at least two compartments each comprising at least one cathode or at least one anode.

According to a particular embodiment of the method of the present invention, the C-gas of step d) is re-circulated to be re-injected into CR2.

According to a particular embodiment of the method of the present invention, the volume % of CO₂ injected in the continuous reactor CR2 in step d) is 0.05-10 volume % per hour.

According to a particular embodiment of the method of the present invention, the DC current ranges from 5 A/m² to 1000 A/m² or the voltage ranges from 0.8 V to 10.0 V volts.

According to a particular embodiment of the method of the present invention, the calcium rich-based aggregates are produced with a CaCO₃ content from 20% to 90%.

According to a particular embodiment of the method of the present invention, the calcium rich-based aggregates are generally produced with an average size from 0.1 mm to 15 mm, but can exceed 50 mm. For instance, the calcium rich-based aggregates are produced with an average size from 0.1 mm to 70 mm, preferably from 0.1 mm to 50 mm, more preferably from 0.1 mm to 15 mm.

Another objective of the present invention is a device or equipment for carrying out the method according to the present invention. Preferably the device or equipment used is as detailed below and illustrated on FIGS. 1 and/or 2.

### Electro (Chemical) Reactions in Cathodic Chamber:

The electrodeposition process of solid minerals in seawater results from a complex interplay of electrochemical redox reactions and precipitation reactions, which lead to the nucleation and growth of minerals around cathodic interfaces. A crucial factor driving electrodeposition is the generation of hydroxide ions (OH⁻) at the cathode, which can occur either through the oxygen reduction reaction (ORR) or through the water reduction reaction (WRR) in seawater, each necessitating different reaction potentials to proceed. The total rate of OH-production is proportional to the resultant current density. However, the reaction selectivity will vary with the applied potential. The generation of OH ions (at the cathode) in the ORR regime is linked to multiple plausible reaction mechanism pathways, with one of these pathways involving the production of H₂O₂ in alkaline media and requiring a thermodynamic voltage of E^{o}cell=−0.841 V. Conversely, in the WRR regime, a different mechanism is at play, necessitating a thermodynamic voltage of E^{o}cell=−1.2287 V for water-splitting. However, an overpotential will always be required to overcome junction potential, series resistance, and slow reaction kinetics.

At potentials of −0.8 V (vs Ag/AgCl, where Ag/AgCl is a reference electrode when using a potentiostat as power source) and −1.0 V (vs Ag/AgCl), the production of OH⁻ at cathode is achieved from ORR (oxygen here is the dissolved oxygen in seawater which is a limiting reactant in the considered closed batch system), as per Equation (1):

O₂+2H₂O+2e [symbol] H₂O₂+20H⁻ (1)

At potentials lower than or equal to −1.2 V (vs Ag/AgCl) (i.e., more negative potentials), selectivity shifts toward OH-production from WRR, evolving hydrogen gas at the cathode, as per Equation (2):

2H₂O+2e [symbol] H₂(⬆)+2OH⁻ (2)

In this regime, hydrogen gas bubbles form at the cathode surface, becoming more noticeable as the magnitude of the applied voltage is increased. If the solution achieves acidic conditions, hydrogen evolution can also proceed following Equation (3):

2H⁺+2e [symbol] H₂(⬆) (3)

With either ORR or WRR, the generation of OH-ions lead to an increase in pH near the cathode surface, with two major effects. On the one hand, nucleation and growth of insoluble Mg(OH)₂ takes place, as per Equation (4):

Mg²⁺+2OH→Mg(OH)₂(⬇) (4)

On the other hand, the carbonate equilibrium expressed in Equation (5) shifts toward a higher concentration of carbonate ions CO₃²⁻, as per Equation (6):

CO₂+H₂O↔H₂CO₃↔H⁺+HCO3+H⁺+CO₃²⁻ (5)

OH⁻+HCO₃→H₂O+CO₃²⁻ (6)

Therefore, insoluble calcium carbonate CaCO₃ can also precipitate following the two typical pathways expressed in Equations (7) or (8):

Ca²⁺+CO₃²⁻→CaCO₃(⬇) (7)

Ca²⁺+HCO₃⁻+OH⁻↔H₂O+CaCO₃(⬇) (8)

CaCO₃ is thermodynamically more stable (ΔG°_{F.,calcite}=−1129.1 KJ mol⁻¹, ΔG°_{F., aragonite}=−1128.2 KJ mol⁻¹, ΔG°_{F., brucite}=−833.7 KJ mol⁻¹). However, the kinetics of Mg(OH)₂ formation overrides thermodynamics due to the higher concentration of Mg²⁺ compared to Ca²⁺ in seawater (typically exhibiting the ratio of about 5:1 for standard salinity conditions and insufficient availability of dissolved carbonates, leading to faster and preferential precipitation of Mg(OH)₂). Specifically, irrespective of the applied potential, Mg(OH)₂ generally precipitates before CaCO₃. As a result of the electrodeposition of Mg(OH)₂, which typically occurs in the form of brucite, the interfacial pH previously raised by the OH production locally decreases, involving two possible consequences. At limited values of potential associated with the ORR regime, the generation of OH⁻ is contingent upon the diffusion of dissolved O₂ and its reduction at the cathode (here for less negative potentials than −1.2 V (vs Ag/AgCl)). Therefore, CaCO₃ minerals can precipitate in the form of aragonite or calcite after the initial precipitation of Mg(OH)₂ because the local pH is sufficient for CaCO₃ precipitations but not for continued Mg(OH)₂ precipitations. In contrast, at significant values of potential associated with the WRR regime, OH⁻ production rate is substantial enough to sustain a pH underpinning Mg(OH)₂ precipitation (here for potentials more negative or equal to −1.2 V (vs Ag/AgCl). Therefore, a continued and preferential deposition of Mg(OH)₂ is observed over CaCO₃ in this regime.

### Counter Reactions in Anodic Chamber:

While reduction reactions take place at the cathode, oxidation reactions take place at the anode, playing an equally important role in the electrodeposition of minerals in seawater. These reactions do not directly contribute to the growth of mineral depositions at the cathode. However, in systems such as the membrane-free batch reactor, they exert an influence that becomes more noticeable for increasingly negative potentials.

The complementary oxidation reactions that proceed at the anode balance the reduction reactions of oxygen and water at the cathode (Equations (1-3)) and consist of oxygen evolution reactions (OER). In the ORR regime, oxygen evolution follows Equation (9), which corresponds to cathodic half-reaction Equation (1):

H₂O₂ [symbol] O₂(⬆)+2H⁺+2e⁻ (9)

In the WRR regime, oxygen evolution follows Equation (10) in alkaline conditions whereas Equation (11) in acidic conditions, which correspond to the cathodic half reactions expressed in Equations (2) and (3), respectively:

4OH⁻ [symbol] O₂(⬆)+2H₂O+4e⁻ (10)

2H₂O [symbol] O₂(⬆)+4H⁺+4e⁻ (11)

A higher magnitude of applied voltage leads to a higher production rate of H₂ and OH⁻ at the cathode and O₂ and H⁺ at the anode, increasing the driving force for H⁺ and OH⁻ ions to diffuse further away from the electrodes at which they are produced. At −1.6 V (vs Ag/AgCl) and more negative potentials, this phenomenon can result in a crosstalk of ions between the electrodes and neutralization of the OH⁻ intended to participate, as per Equation (12):

H⁺+OH⁻→H₂O (12)

Besides the dissolved oxygen (O₂) that is naturally present in seawater and water (H₂O) itself, various other chemical species present in seawater can undergo multiple redox reactions based on their standard reduction potential and the applied potential.

In the WRR regime, additional potential reaction pathways involve chlorine oxidation at the anode, as per Equations (13-22). Equations (13-15) are feasible in alkaline conditions, whereas Equations (16-22) are feasible in acidic conditions, especially at-1.6 V (vs Ag/AgCl):

Cl⁻+6OH [symbol] ClO₃⁻+3H₂O+6e⁻ (13)

Cl⁻+4OH [symbol] ClO₂⁻+2H₂O+4e⁻ (14)

Cl⁻+2OH [symbol] ClO⁻+H₂O+2e⁻ (15)

ClO₂+H₂O [symbol] ClO₃⁻+2H⁺+e⁻ (16)

ClO₃⁻+H₂O [symbol] ClO₄⁻+2H⁺+2e⁻ (17)

2Cl⁻ [symbol] Cl₂(⬆)+2e⁻ (18)

Cl⁻+4H₂O [symbol] ClO₄⁻+8H⁺+8e⁻ (19)

Cl⁻+3H₂O [symbol] ClO₃⁻+6H⁺+6e⁻ (20)

Cl⁻+H₂O [symbol] HCIO+H⁺+2e⁻ (21)

Cl⁻+2H₂O [symbol] HClO₂+3H⁺+4e⁻ (22)

The wide array of such secondary reactions stems from the versatility of Cl⁻ ions to adopt various oxidation states, ranging from +1 in NaCl to +7 in ClO4⁻ and their dependency upon the pH and the applied potential, which is observed from the Pourbaix diagram of Cl⁻ in seawater.

These reactions at anode do not appear to influence the composition of electrodeposits, but they can affect the total yield of the electrodeposits by consuming OH⁻ which participates in electrodeposition if used in a membrane free one pot reactor. Ion selective membranes can prevent the passage of OH⁻ from cathodic to anodic chamber and allows only Equation 9 and Equation 11 and Equation 16-22 on anode. The role of OH ions is to enhance the formation of carbonates, leading to CaCO₃ precipitation, balancing the decrease in pH caused by CO₂ injection, routing towards neutralization reaction, as well as participating in precipitation reaction that produces Mg(OH)₂. To achieve these goals, stoichiometrically, it is required to generate 4 moles of hydroxide (OH⁻) at the cathode to transform 1 mole of injected CO₂ into 1 mole of CaCO₃ or MgCO₃, while simultaneously producing 1 mole of Mg(OH)₂ or Ca(OH)₂ without affecting pH of effluent seawater. The precipitation of specific types of mineral hydroxide Mg(OH)₂ or Ca(OH)₂ or mineral carbonate CaCO₃ or MgCO₃ and their specific percentage weight is governed by their saturation indices in seawater as well as several other factors including the chemistry of seawater, concentration of OH, CO₃²⁻, Ca²⁺, and Mg²⁺, electrode material features, electrochemical cell design, and magnitude of applied electrochemical potential/current.

### Example of Implementation of the Method of the Invention and Equipment/Device Used

According to a first embodiment of the invention summarized in FIG. 1, AS1 is mainly consisting of salty water, such as sea, ocean water, brines, solution residues from the industry, salt solutions, etc. or any mixture thereof having magnesium and/or calcium and/or strontium ions which are eligible to form their insoluble carbonates and/or hydroxides as solid precipitates in aqueous solution.

AS1 is pumped using for instance—but not limited to—a pumping system P0, into the conditioning reactor CR1 after passing through a filter system F1 located uphill from the reactor CR1, to remove organic debris or other pollutants and produce an aqueous salty solution AS2. The filter F1, for instance, consists of metallic grids (mesh-mesh), organic or inorganic fibers or any conventional water filtration material. AS2 is brought in CR1, where the pH and the temperature of AS2 entering CR1 are measured and regulated, to meet the operating conditions of the electrodeposition, to produce an aqueous salty solution AS3.

CR1 is equipped with heating and cooling devices respectively HD and CD, that can be located inside or outside the reactor vessel CR1V. HD is preferably heated using electrical or gas fired heating elements. The heating/cooling devices HD/CD can be an integrated heat exchanger or heat pumps or any other heating device. When located inside the reactor vessel CR1V, the heating and cooling devices HD and CD should be made of anti-corrosive materials, due to the natural corrosive properties of salty water. Heating devices HD that can be used are for example jacketed vessels, immersion heater, coils, or heat exchanger. Cooling devices CD that can be used are for example heat exchangers, jacketed vessels, or cooling coils. The temperature regulation is done using conventional thermos-elements to measure the temperature and commercially available temperature regulators acting on the heating and cooling devices. The temperature is from 18° C. to 29° C., preferably from 20° C. to 25° C.

The pH is regulated inside CR1 using industrially available pH meters, electronic regulators connected to acid (such as 0.01 to 100 volume % of H₂CO₃, HCl or base (such as 0.01 to 100 volume % of NaOH, Na₂CO₃) dispensers equipped with dosing devices. The pH is from 7.1 to 9, preferably from 8.0 to 8.4.

The aqueous solution in CR1V (ASCR1) is agitated using propellers or pumps located inside or outside the vessel V1 of CR1. Preferably, the agitation pumps can be the pumps (not showed) used to circulate ASCR1 through the HD and CD located outside CR1V.

Alternatively, additional industrial brines or salt solution can be added to AS1 prior to the filter F1 or directly to ASCR1.

The conditioning reactor CR1 typically comprises a vessel V1 in rectangular or tube form or any other form suitable for the purpose. The volume of CR1 (CR1ᵥₒₗ) is defined by a relation between the volume of the second reactor CR2 (CR2ᵥₒₗ) and the flow of AS3 in CR2.

According to FIG. 1A: The conditioning reactor CR1 as a batch reactor of volume CR1ᵥₒₗ, feed AS2 in CR1 and prepare AS3 in time t1 and once achieve the required pH and temperature, feed the output of CR1 i.e., AS3 to CR2 (a continuous flow reactor) of volume CR2ᵥₒₗ at a flowrate FRAS3 till the volume in CR1 i.e., CR1ᵥₒₗ gets consumed completely. Stop the operation. In the meantime, prepare the next batch of AS3 in CR1 and simultaneously clean aggregates and electrodes from CR2 in time t2. Start the operation in CR2 again when the next CR1 batch is ready. And repeat the process. CR2 cleaning time t2 is adjusted as per CR1 conditioning time t1. In this case, with the assumption that CR1 and CR2 operate independently and there is no time overlap between CR1 and CR2 operations, i.e., CR2 cleaning (t2) occurs while CR1 is preparing the next batch, a relationship can be derived. The volume of CR1 (CR1ᵥₒₗ) needs to be at least as large as the volume of CR2 (CR2_{Vol}) since CR2 should be filled to its capacity during the continuous operation. The flow rate of AS3 (FRAS3) should match the consumption rate in CR1 over time CR1T1 to achieve a steady state flow in CR2. Therefore, the relationship between CR1ᵥₒₗ, CR2ᵥₒₗ, and FRAS3 is as follows: CR1_{Vol}−CR2_{Vol}=FRAS3*CRIT1 (to match the consumption rate in CR1).

According to FIG. 1B: CR1 composed of CR1A and CR1B, where CR1A as conditioning reactor which is a batch reactor and CR1B as reservoir or storage vessel which is a semi-continuous flow reactor and CR2 as a continuous flow reactor where aggregates forms. Use of a reservoir CR1B, between CR1A and CR2, of volume larger than (at least 2.5 times) CR1A and CR2 can allow continuous operation of CR2. Prepare conditioned water AS3 in CR1A, transfer AS3 to reservoir CR1B and then continue the flow of AS3 from reservoir to CR2 continuously. Keep preparing the conditioned water in CR1A and keep transferring it to the reservoir so that it can allow the continuous operation of CR2 as long as required at a flowrate FRAS3. In the batch reactor, the volume (CR1Aᵥₒₗ) remains constant during each batch operation. The volume of CR1B (CR1B_{Vol}) can be related to the flow rate of AS3 into CR2 (FRAS3) based on the principle that CR1B provides AS3 to CR2 continuously at a flow rate FRAS3. AS3 is pumped from CR1 or CR1B using the pumping system P1 to ensure a flow rate FRAS3 of (area of cross section velocity of flow) in the CR2 vessel, so that the AS3 velocity is maintained between 0.01 m/s and 5 m/s.

The continuous reactor CR2 is in the form of a closed container, in the form of a parallelepiped or a cylinder or any 3-dimensional shape with one dimension larger than the other 2. CR2 is equipped with a pumping system P1 to pump AS3 from CR1 into CR2 through at least one inlet CR21 and at least one outlet CR20. The characteristics of the pump system P1 are selected so the flow rate FRAS3 of aqueous solution AS3 into the reactor CR2 is determined by the cross section of the reactor CR2 to obtain a velocity or displacement speed VAS3, located between 0.01 m/s and 5 m/s. The continuous reactor CR2 is equipped with an electroactive substrate comprising at least one cathode electrode and one anode electrode of any shape (cylindrical, concentric, flat plate, curved plate, grid, porous plate, or rod) that are in contact with the AS3 and are connected to an electrical DC supply/DC electrical power source to apply a controlled voltage or current between the cathode(s) or the anode(s). The CR2 can be also equipped with at least one online pH measuring device and one online temperature measuring device. The continuous reactor CR2 is equipped with at least one C-Gas injection device CGI located near the cathode in the lower part of the reactor, and at least a C-Gas collection device (CGC located in the upper part of the CR2 reactor).

Cathodes contemplated in this invention comprise materials selected from the group consisting of stainless steel (SS), aluminum (Al), nickel (Ni), and mixed metal oxides (MMO). Stainless steel offers good corrosion resistance and durability, while aluminum and nickel may require additional treatments for enhanced corrosion resistance. MMO-coated stainless-steel cathodes improve electrocatalytic activity and corrosion resistance. This innovation includes flat plate cathodes, mesh cathodes, and tubular cathodes among other cathode shapes. These forms can be modified to fit various CR2 reactor arrangements. Cathode sizes can be modified to fit the configurations and capacities of CR2 reactors. They could be made of tiny plates, bigger panels, mesh or porous plates or tubular structures. The active surface of the cathodes in contact with AS3 is typically selected to be located between 0.01 to 0.5 m² per m³ of AS3, preferably between 0.1 to 0.15 m² per m³ of AS3.

The anode components may be made of mixed metal oxides (MMO), titanium (Ti), graphite, and platinum (Pt). In seawater, titanium offers great resistance to corrosion, whereas platinum and MMO have a high electrocatalytic activity. The corrosion resistance of titanium and the electrocatalytic qualities of metal oxides, such as ruthenium oxide or iridium oxide or tantalum oxide, are combined in MMO-coated anodes. Anodes can have coatings applied to improve their performance. Options for coatings include Platinum, Platinum-Palladium, IrO₂, RuO₂, IrO₂—Ta₂O₅, IrO₂—RuO₂, mixed metal oxides (MMO) coatings on Titanium base (grade1 or grade 2) to improve electrocatalytic characteristics, and platinum-iridium coatings to improve durability and performance. Anodes can encompass a variety of shapes, such as flat plate anodes, mesh anodes, and tubular anodes. These shapes can be modified to fit the CR2 system's unique specifications and needs. The CR2 reactor's size and capacity have an impact on the anode's size. Anode sizes can range from small discs to large panels, depending on the reactor's specs and production needs.

Electrodes (both cathode and anode) may also be coated with conductive and non-corrosive material such as Platinum-coated Titanium, Iridium-coated titanium, IrO₂ coating, Mixed metal oxide (MMO) coating, polymer coating (e.g. perfluorosulfonic acid (PFSA)) etc.

The surface area ratio (SAR) between the cathode and anode surfaces should fall within the range of 1 or 3, preferably between 1 to 1.5. A SAR less than 1, indicating a smaller cathode and a larger anode, results in increased production yield but a higher Mg(OH)₂ content in aggregates. Conversely, a SAR exceeding 1.5, indicating a larger cathode and a smaller anode, compromises aggregate yield. SAR significantly influences various factors, including reaction rates, mass transport, current density, electrodeposition uniformity, and energy efficiency in electrochemical processes. Optimal solid product output is achieved by selecting a SAR between 1 and 1.5. Ratios above this range demand enhanced energy efficiency, while ratios below this range may accelerate electrode degradation and raise anode costs.

The electrochemical reactor (CR2) is designed to operate on DC power supply. The DC supply in the system typically utilizes a rectification circuit to convert alternating current (AC) power from the electrical grid into direct current (DC) power. This DC supply is intended to supply the electrochemical reactor with a consistent and controlled voltage and current. A standard auto range DC supply operating in the range 0-100V and 0-50 A, available market options such as 6V & 5A or 20 V & 2 A or 30 V & 5 A or 35 V & 1A or 60 V & 40 A or a custom designed DC supply in the specified operating range can be used. The voltage and current levels within the reactor can be adjusted as needed to optimize the electrochemical processes, ensuring effective aggregates production while maintaining system safety and control. For instance, a constant DC current ranging from 1 A/m² to 5000 A/m², preferably from 5 A/m² to 1000 A/m², the m² representing the deployed surface of the electrodes in contact with AS3, or a voltage ranging from 0.5 V to 20.0 V, preferably from 0.8 V to 10.0 V volts, is applied, to the electrodes.

When working with low current and voltage, solid deposits can accumulate on the surface of the electrodes over time. Once these deposits reach the required size or thickness, one alternative to remove the precipitated material is to apply a high voltage to crack or dislodge the solid deposits from the electrode surface. The cracked solids then fall to the bottom of the container or system for later collection.

According to FIG. 1B, all electrodes (anodes and cathodes) can be placed in the compartment of the vessel CR2V. In the first preferred embodiment of the invention, where all electrodes, including both anodes and cathodes, are positioned inside the compartment of the vessel CR2V, some layouts can be taken into consideration:
Layout 1, Single bipolar electrode configuration: Cathode and anode are placed on opposite sides of the compartment separated by a distance to avoid cross talks of ions and interference in reactions, creating a bipolar or divided electrode setup. This arrangement allows for controlled ion movement from cathodes to anodes, facilitating distinct electrochemical reactions on either side.
Layout 2, Multiple bipolar electrodes configuration: where multiple cathodes are connected in series separated by a distance from multiple anodes connected and located at specified distance from cathode to avoid short circuiting, this arrangement of multiple cathodes and anodes on opposite sides of the compartment provides larger surface area for aggregates growth and allows for controlled ion migration through the electrolyte from the cathodic side to the anodic side, promoting specific electrochemical reactions.
Layout 3, Multiple electrodes parallel configuration: where alternating cathode and anode with the opposite polarity placed in parallel separated by a distance or separator to avoid short circuiting. This set up encourages efficient ion transport and uniform dispersion of the electrical field.
Layout 4, Centralized configuration: In this configuration, a central anode or cathode is surrounded by multiple opposing electrodes, forming a radial arrangement separated by a distance. This layout facilitates controlled ion migration towards or away from the central electrode, allowing for specific reaction sequences.
Layout 5, Mesh or Grid configuration: Anodes and cathodes can be designed as mesh or grid structures, which provide a high surface area for interaction with the electrolyte. They may be positioned adjacent to each other or woven together separated by a separator to avoid short circuiting. This layout enhances mass transfer and reaction efficiency.
Layout 6, Spiral or helical configuration: under which electrodes can be arranged in a spiral or helical manner along the interior of the compartment separated by a separator to avoid short circuiting. This layout maximizes space utilization while facilitating uniform electrolyte flow and ion exchange.

The distance between the cathodes and anodes in the electrochemical reactor can significantly impact the efficiency and effectiveness of the electrochemical processes. The optimal distance between them depends on several factors, including the electrical conductivity of cathodes and anodes, their sizes, the desired reaction rates, and the hydrodynamics of the electrolyte which can be in the range of 5-100 cm or maximum available as per size of the reactor vessel and electrodes.

The C-Gas (preferably containing from 10% to 100% CO₂, more preferably from 20 to 100 volume % of CO₂) is injected below the electrodes specifically cathodes, using one or many entry points (CGI) to the vessel CR2V, and may include a C-Gas piping system inside the vessel CR2V to distribute the C-Gas evenly in the vessel CR2V in contact with the aqueous salty solution AS3. The C-Gas bubble towards the surface of AS3 and is collected in the upper part of the CR2 reactor. The C-Gas collected can then be re-circulated using a circulating device GL (for example, at least one pipe and one gas circulating pump, a fan or blower connecting the upper part of CR2 to CGI), to be re-injected into the vessel CR2V. The C-Gas recirculating system can be connected to a source of CO₂-Rich gas (containing up to 100% CO₂) to maintain the CO₂ content in the C-Gas above 20% volume %, preferably between 30 and 50 volume %, and compensate for the CO₂ depletion of the C-Gas by the carbonation reaction in the CR2 vessel. The CO₂-rich source can be pure CO₂ or any gas or industrial flue gas having a CO₂ content significantly higher than the minimum CO₂ content required in the C-Gas. The C-gas is injected into AS3 using a C-gas mass flow controller and can be selected by flowrate of gas injection or volume of CO₂ required to be injected or concentration of CO₂ needed to be injected in AS3 for enhanced growth rate. The flow rate of CO₂ injection from C-gas stream can be adjusted in the range of 0 to 1000 sccm (standard cubic centimeters per minute) per cubic meter of AS3 preferably in the range of 100-300 scc per minute per cubic meter of AS3. The C-gas flow rate in reactor CR2 is selected so that the volume % of CO₂ injected in AS3 should be 25-30 total volume % of AS3, or so that the volume % of CO₂ injected in CR2 is 0.05-10 volume % per hour, preferably 0.05-5 volume % per hour, more preferably from 0.4-5 volume % per hour. C-gas flow rate can be calculated using the relation (in volume units per hour)=(Volume % of CO₂ desired*100)*(Volume of the reactor (CR2))/time.

The process and parameters (temperature and pH of AS3, flow rate of AS3) are maintained constant for some hours to some days (e.g. 24-168 hours, 7 days, or 30 days), until the electrodeposited aggregates are removed from the bottom of CR2 and/or the surface of the electrodes, and post-processed (washing, drying, remove salt traces, grinding, etc.) to be used typically in the material construction industry (cement, mortar, asphalt, concrete, or limestone-based industry).

According to FIG. 2, the vessel CR2 may contain at least 2 compartments CR2VA and CR2VC containing respectively the anodes and the cathodes. The invention is not limited to 2 separate compartments and depending on the design of the vessel, additional compartments are covered by the invention. The two compartments are separated from one another for instance by a separator such as a membrane.

The choice of membrane type and its details are essential for the proper functioning of the electrochemical system. The specific membrane chosen depends on the electrochemical processes taking place in the compartments, the ions involved, and the desired selectivity. Membranes are critical for maintaining the integrity of the separate compartments, preventing unwanted reactions, and controlling ion transport between the anodes and cathodes. Here are some common types of membranes used in such setups and how they work:

on-Selective Membranes: Ion-selective membranes are designed to allow specific ions to pass while blocking others. They work based on the principle of selective ion transport. For example, cation-selective membranes (CSM) permit the passage of positively charged ions (cations) while blocking negatively charged ions (anions). Anion-selective membranes (ASM) perform the opposite function. Cation selective ion provides the option to permit the possible cations such as Ca²⁺, Mg²⁺, Na⁺, Sr²⁺, K⁺, H⁺ not limited to and other possible cations in AS3 and anion selective membranes permits anions such as OH⁻, Cl⁻, HCO₃, CO₃²⁻ not limited to from one compartment to another. Examples of such membranes but not limited to include sulfonated tetrafluoroethylene-based fluoropolymer-copolymer, a fluorinated ion-exchange membrane, perfluorosulfonic acid based, organic polymer materials such as polystyrene polymer-based, conducting polymer-based membranes.

Permeable Membranes (PM): These membranes are designed to allow the passage of specific molecules or ions based on size and charge. They provide a controlled barrier between compartments, regulating the exchange of species while preventing mixing. Examples of such separators include, but are not limited to, polytetrafluoroethylene, polyvinylidene Fluoride, cellulose acetate, polyethersulfone and mixed cellulose ester membranes.

Separator Membranes (SM): Separator membranes are designed to physically separate the compartments to prevent direct contact between anodes and cathodes. They are typically made of materials that are chemically stable and resist corrosion in the harsh electrochemical environment. Examples of such separators include but are not limited to, glass fiber separator, polypropylene separator, ceramic separator, and nonwoven separator membranes.

Additionally, the invention allows for flexibility in the design, which means that additional compartments with appropriate membranes can be incorporated based on the specific needs and goals of the electrochemical system, further enhancing its versatility and adaptability.

This layout presents various advantages:
to collect separately the gases that are produced respectively on the anode (Cl₂, O₂) and on the cathode (H₂).
to preferably inject CO₂ only or mainly in the compartment containing the cathodes,
thus, avoiding mixing other produced gas such as Cl₂ with the recirculating C-Gas

FIG. 2a) shows an example of a second preferred embodiment according to the invention where the reactor CR2 has 2 chambers (or compartments) arranged in series.

FIG. 2b) shows an example of a second preferred embodiment according to the invention where the reactor CR2 has 2 chambers (or compartments) arranged in parallel.

For the series arrangement (FIG. 2a) the entry point or points of AS3 in the vessel CR2V are located in the cathodic compartment and the outlet(s) point or points of AS3 in the vessel CR2V are located in the anodic compartment.

For the parallel arrangement (FIG. 2b), the vessel CR2V has a dedicated, specific entry for AS3 in both the anodes-containing compartment and in the cathodes-containing compartment, whereas the outlet of AS3 will be located in the anodic compartment or in both the cathodic and anodic compartments.

In both cases, respectively in FIGS. 2a) and FIG. 2b), the upper part of the reactor CR2 provides 2 separate gas collecting devices, respectively one for the cathode compartment collecting H₂ and CO₂ to be recirculated and one for the compartment containing the anodes collecting O₂ and Cl₂ to be further post-processes (not shown).

Preferably, a design using multiple compartments will have chambers arranged in series, with an equal number of cathodes-containing compartments and anodes-containing compartments.

### Definitions

Aggregates. Inert granular material that comprises as much as 60% to 80% of a typical concrete mix. It is composed of geological materials such as gravel, sand and crushed rock. The size of the particles determines whether it is a coarse aggregate (8-32 mm) or a fine aggregate (4-8 mm). Lower than 4 mm aggregates are defined as “Sand”. Concrete aggregate can be used in its natural state or crushed, depending on the use and application of the concrete.

Anode. The anode is the positively charged electrode, attracting electrons or anions.

Asphalt. A mixture of dark bituminous pitch with sand or gravel, used for surfacing roads, flooring, roofing, etc.

Batch reactor. It is a non-continuous type of reactor where the reactants are fed into the reactor all at once initially. The vessel contains an agitator and an internal heating or cooling system.

Binder. Material with cementing properties that sets and hardens due to hydration even under water. Hydraulic binders produce calcium silicate hydrates also known as CSH.

Brine. Water strongly impregnated with salt.

Carbonation. Carbonation is the reaction between carbon dioxide gas and a solid (for example, minerals) or liquid (for example, water).

Cathode. The cathode is the negatively charged electrode. Attracting cations or positive charges.

Cement. It is a binder that sets and hardens and brings materials together. The most common cement is the ordinary Portland cement (OPC) and a series of Portland cements blended with other cementitious materials.

Concrete. A building material made from a mixture of broken stone or gravel, sand, cement, and water, which can be spread or poured into moulds and forms a mass resembling stone on hardening.

Continuous reactor. Reactors that carry material as a flowing stream. Reactants are continuously fed into the reactor and emerge as a continuous stream of product.

Crystal. A solid whose atoms are arranged in a “highly ordered” repeating pattern.

DC Power supply. A type of power supply that gives direct current (DC) voltage to power a device. Direct current (DC) is a type of electrical current that flows in only one direction. Batteries and solar cells supply DC electricity.

Electric potential. The amount of work energy needed per unit of electric charge to move this charge from a reference point to the specific point in an electric field.

Electroactive substrate. In voltammetry and related techniques, a substance that undergoes a change of oxidation state, or the breaking or formation of chemical bonds, in a charge-transfer step.

Electrode. A conductor through which electricity enters or leaves an object, substance, or region.

Electrodeposition. Deposition of a substance on an electrode by the action of electricity. It is a process that uses electric current to reduce dissolved cations so that they form a coating or a deposit on an electrode.

Greenhouse gas. A gas that contributes to the greenhouse effect by absorbing infrared radiation. Carbon dioxide and chlorofluorocarbons are examples of greenhouse gases.

Hydration. It is the mechanism through which OPC or other inorganic materials react with water to develop strength. Calcium silicate hydrates are formed and other species like ettringite, monosulfate, Portlandite, etc.

Hydraulic binder. It is a material with cementing properties that sets and hardens due to hydration even under water. Hydraulic binders produce calcium silicate hydrates also known as CSH.

Limestone. A hard sedimentary rock, composed mainly of calcium carbonate or dolomite, used as building material and in the making of cement.

Mineralization. Carbon mineralization is the process that chemically transforms carbon into solid mineral (carbonate). It occurs in nature when certain rocks are exposed to carbon dioxide. Mineralization may be accelerated and used to capture CO₂ in various minerals and materials using different conditions like temperature, pressure, or humidity. The advantage of this process is that CO₂ becomes permanently bound and cannot escape back to the atmosphere.

Minerals. A naturally occurring inorganic solid that has a definite chemical composition, and an ordered internal structure.

Mortar. Mortar is made from cement, sand, and sometimes lime or admixtures, and is used for bonding bricks, stones, and other materials.

Ordinary Portland cement (OPC). Hydraulic cement is made from grinding clinkers with gypsum. Portland cement contains calcium silicate, calcium aluminate and calcium ferro-aluminate phases. These mineral phases react with water to produce strength.

Overpotential. The potential difference (voltage) between a half-reaction's thermodynamically determined reduction potential and the potential at which the redox event is experimentally observed.

Polymorphs. A condition when a solid chemical substance exhibits more than one crystalline form.

Potentiostat. A potentiostat is an electronic device that measures and controls the potential difference (voltage) and current between two electrodes by using three electrodes (working electrode as cathode, counter electrode as anode and reference electrode) electrochemical cell. It is commonly used to study electrochemistry involving electrochemical reactions such as battery, electrodeposition, corrosion etc.

Reactant. A substance that takes part in and undergoes change during a reaction.

Sand. Manufactured, natural or recycled minerals with a particle size lower than 4 mm.

Selectivity. Ratio of the desired product to the undesired product formed.

Silicate. Silicates are responsible for mechanical properties of cement.

Stoichiometric. It is the relation between the quantities of substances that take part in a reaction or form a compound.

Strength development—setting/hardening. The setting time starts when the construction material changes from plastic to rigid. In the rigid stage the material cannot be poured or moved anymore. After this phase the strength development corresponds to the hardening of the material.

Surface area. The total area covered by all the faces of a 3D object.

Voltage. The difference in electric potential energy per unit charge between two points. A voltage which is a measure of electric potential difference, is the cause of electrical current to flow in a closed circuit.

Yield. A measure of the quantity of moles of a product formed in relation to the reactant consumed, obtained in a chemical reaction, usually expressed as a percentage.

Abbreviations used to describe the system

| | |
|---|---|
| AS1 | Initial aqueous solution to be handled |
| ASCR1 | Aqueous solution inside the vessel VCR1 or the reactor |
| | CR1. |
| AS2 | Aqueous solution leaving the reactor CR1 at a given |
| | temperature and pH. |
| CR1 | Conditioning set of reactors (1 or more) to set and |
| | regulate the temperature and the pH of the aqueous solution |
| | entering CR1 |
| V1 | Vessel of CR1 |
| AS3 | Aqueous solution with set pH and temperature in reactor |
| | CR1 |
| CR2 | Continuous reactor for the electro deposition of minerals |
| | from AS3 |
| V2 | Vessel of the reactor CR2 |
| CR2I | Inlet of reactor CR2 |
| CR2O | Outlet of reactor CR2 |
| FRAS3 | Flow rate of AS3 from CR1 into CR2 in m3/h |
| VAS3 | Velocity of AS3 in CR2 in m/s |
| C-Gas | CO2 containing gas injected below the electrodes in CR2 |
| | and collected at the upper part of the reactor CR2 |
| CGI | Injection C-gas device CR2 |
| CGC | Collecting C-gas device in CR2 |
| CR1V | Vessel of the reactor CR1 |
| HD | Heating devices in CR1 |
| CD | Cooling devices in CR1 |
| CR2V | Vessel of the reactor CR2 |
| V (vs SHE) | Voltage with reference to standard hydrogen electrode |
| V (vs Ag/ | Voltage with reference to silver-silver chloride reference |
| AgCl) | electrode |
| P1 | Pumping system to pump AS3 from CR1 into CR2 |
| P0 | Pumping system to pump AS1 into CR1. |
| F1 | Filter system that strains AS1. At the exit of F1, AS1 |
| | becomes AS2. |
| CR1_{Vol} | Volume of CR1 |
| CR2_{Vol} | Volume of CR2 |
| CR1T1 | Consumption rate in CR1 over time |
| CR1A | Batch, conditioning |
| CR1B | Reservoir or storage vessel which is a semi-continuous flow |
| | reactor |
| AS3′ | Conditioned water prepared in CR1A |
| CR1A_{Vol} | Volume of CR1A |
| CR1B_{Vol} | Volume of CR1B |
| GL | Circulating device to recirculate C-Gas |
| CR2VA | Compartment in the vessel CR2V that contains the anode |
| CR2VC | Compartment in the vessel CR2V that contains the cathode |

### BRIEF DESCRIPTION OF THE FIGURES

FIG. 1 shows a general view of the methodology/process according to the invention.

FIG. 2A and FIG. 2B show an alternative for reactor CR2 using multiple chambers for respectively the anodes and the cathodes (2a) example of a second preferred embodiment according to the invention where the reactor CR2 has 2 chambers (or compartments) arranged in series (2b) example of a second preferred embodiment according to the invention where the reactor CR2 has 2 chambers (or compartments) arranged in parallel.

FIG. 3 shows the macroscopic view of the dried electrodeposited solid minerals produced at or near the stainless-steel cathode from laboratory experiments of a 2-liter vessel without and with CO₂ injection. The macroscopic size of the aggregates varies between 0.01-5 mm depending upon the magnitude of applied current or voltage and white/pale white in color.

FIG. 4 shows the macroscopic view of the dried electrodeposited aggregates (A) at constant current (B) at constant voltage, produced at or near the stainless-steel cathode from laboratory experiments of a 2-liter vessel. The macroscopic size of the aggregates varies between 0.01-5 mm depending upon the magnitude of applied current or voltage and white/pale white in color.

FIGS. 5A-5C shows by scanning electronic microscopy (SEM) of the morphological features of the dried electrodeposited aggregates on microscopic scale that resemble brucite, aragonite and calcite polymorphs ranging from numerous small petals forming a fibrous interwoven structure of brucite particles appearing as flower petals, to elongated needle-like columnar structures of aragonite, to cubic subhedral microcrystals of calcite appearing as small cubes.

FIGS. 6A and 6B shows the relationship between the total mass of electrodeposited aggregates and the injected CO₂ flow rate at an applied electrochemical current (−240 mA or −840 A/m², FIG. 6A) and voltage (−2 V vs Ag/AgCl, FIG. 6B).

FIGS. 7A-7D illustrates the percentage weight of (7A) polymorphs determined by XRD (7B) CaCO₃ and Mg(OH)₂ estimated from TGA at an applied current of −240 mA or −840 mA/cm² (7C) polymorphs determined by XRD (7D) CaCO₃ and Mg(OH)₂ estimated from TGA at an applied voltage of −2 V (vs Ag/AgCl).

FIG. 8A and FIG. 8B shows the normalized production rate and energy consumption (8A) at an applied current of −240 mA or −840 mA/cm² (8B) at an applied voltage of −2 V (vs Ag/AgCl).

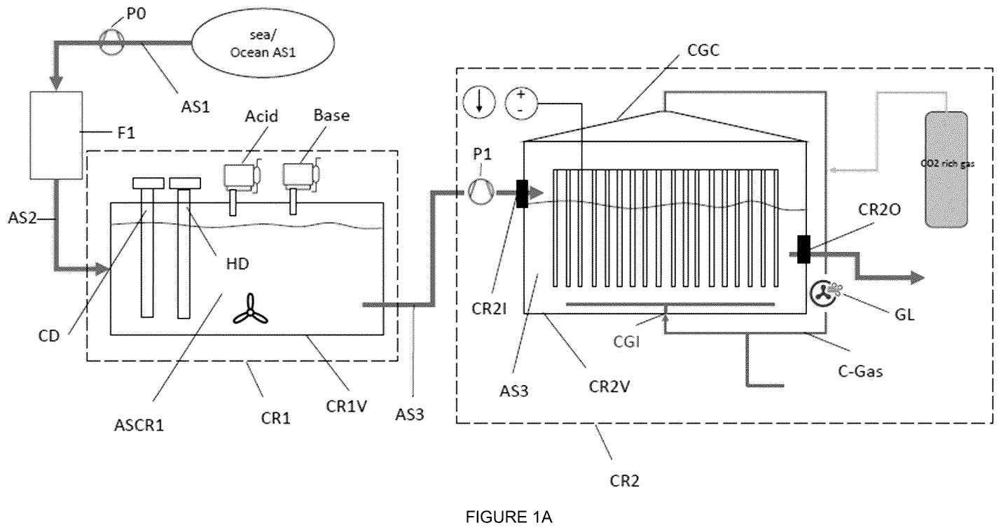

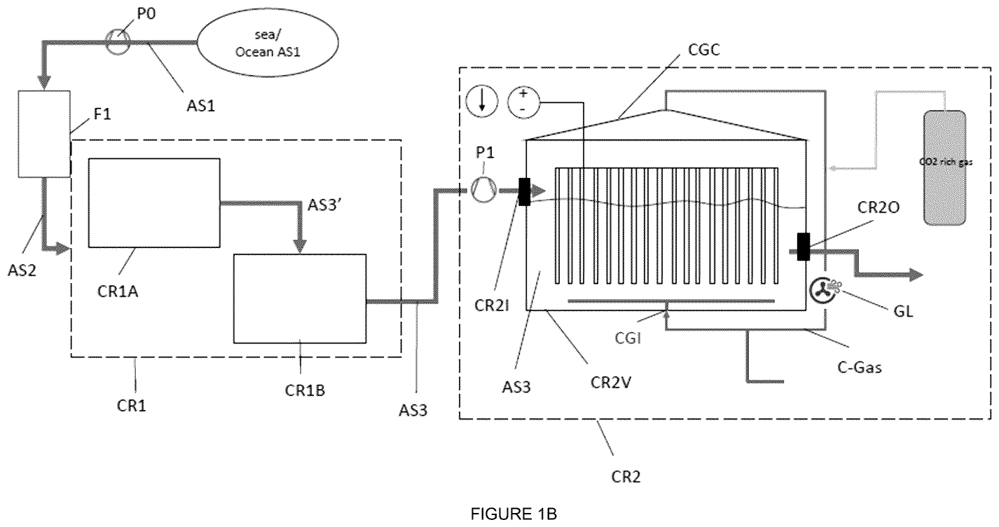

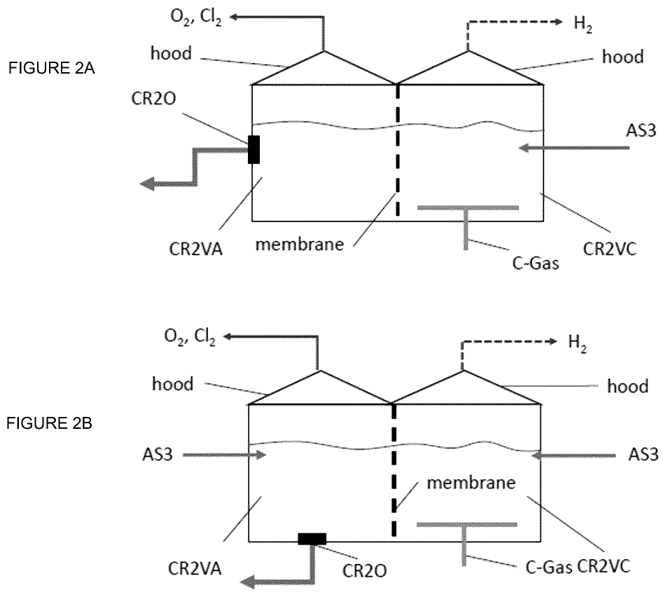

### EXAMPLES

### Example 1: Materials and Methods

### Synthesis of Artificial Seawater

Artificial saltwater was synthesized using sea salt (ASTM D1141-98) from Lake Products Company LLC and Type 1 ultrapure water (18.2 Mwcm of resistivity at 25° C.) from Millipore Sigma. As a result, 41.953 g of sea salt was completely dissolved in 1 liter of water to meet the ASTM D1141-98 requirement. Instant mixed seawater was found to have a pH that ranged from 8.3 to 8.4 at ambient temperatures.

### CO₂ Injection Pathway

A mass flow controller of range 0.01-300 sccm (standard cubic centimeter per minute) from Alicat Scientific Inc. was used for CO₂ injection.

CO₂ injected from a gaseous stream of 0.01% to 100% CO₂ at a flowrate so that the concentration of CO₂ in cathodic chamber injected in the range 30-100 mM in seawater. For a reactor vessel of 2-liter, the flowrate between 0.15-0.45 sccm (standard cubic centimeter per minute) from a 99.9% concentrated CO₂ stream can maintain the required concentration.

### Electrochemical Treatment

All the experiments have been performed on a batch scale on a 2-liter artificial seawater in a controlled laboratory setting. Initially, the system is allowed to equilibrate for 1 hour as the open circuit potential is measured. Electrodeposits are created by applying a constant current or voltage for a time 24 or 72 or 120 or 168 h (i.e., 1 day-7 days) using a DC power source. The working current range is 1-5000 A/m² including 1, 5, 10, 15, 20, 25, 30, 35, 40, 45, 50, 55, 60, 65, 70, 75, 80, 85, 90, 95, 100, 200, 300, 400, 500, 600, 700, 800, 900, 1000, 1100, 1200, 1300, 1400, 1500, 1600, 1700, 1800, 1900, 2000, 3000, 4000, 5000 A/m². The working potential range is 0.1-10 V including voltages of −0.8, −1.0, −1.2, −1.4, −1.6, −1.8, −2, −3, −4, −5, −6, −7, −8-, −9, −10 V (vs Ag/AgCl i.e. silver-silver chloride) corresponding to −0.803, −1.003, 1.203, and −1.403, −1.603, −1.803, −2.803, −3.803, −4.803, −5.803, −6.803, −7.803, −8.803, −8.803, −9.803 V (vs SHE i.e. standard hydrogen electrode).

### Removing Solid Deposits:

Shutdown the reactor: Before performing any maintenance, ensure that the electrochemical reactor is safely shut down, and power to the anode and cathode is disconnected. Removal of solid deposits involves removal from the cathode surface as well as removal from the reactor surface.
Mechanical removal of solid aggregates: Depending on the location of the solid deposits on the cathode at the bottom of the reactor, the use of mechanical means to scrape or brush them off the cathode and the reactor's surface can be employed. Firstly, application of a voltage higher than operational voltage or ultrasonic waves can be used to dislodge aggregates from the electrode surface. Then, empty the reactor by filtering out the aqueous solution from the reactor using a filtration unit at the outlet followed using electrically operated scrappers to remove the aggregates from the bottom of the reactor through aggregates outlet.
Or in another configuration, dislodge the aggregates from the electrodes by applying higher voltage as operational voltage and resulting in falling down all the solids at the bottom of the reactor. Then all the aqueous solution from the reactor containing aggregates and aqueous stream can be subjected to a vacuum filtration bed where aggregates can be filtered out using gravity or rotational filtration bed and sent for drying and aqueous filtrate can be discharged upon environmental testing.
Cleaning of electrodes and reactor:
Scraping and Brushing: Tools like metal or polymer scrapers and brushes can be used to physically dislodge deposits from the cathode and reactor surfaces.
Ultrasonic Cleaning of cathode: Ultrasonic cleaning involves the use of high-frequency sound waves to create tiny, high-energy bubbles in a cleaning solution. These bubbles can dislodge and remove deposits from surfaces. This method is effective for cleaning intricate or hard-to-reach areas and can be gentle on materials. The cleaning solution can be filtered out from the outlet and solids can be obtained on filtration unit.

High-Pressure water Jet Cleaning: High-pressure water jet cleaning utilizes pressurized water to dislodge and remove deposits. This method is effective for removing tough, adherent deposits. It's important to adjust the water pressure to a level that can remove deposits without damaging the stainless steel and titanium. Abrasive Cleaning: Abrasive methods involve using abrasive materials, such as sandpaper, wire brushes, or abrasive compounds, to physically scrub away deposits.

Sanding and Polishing: In some cases, light sanding and polishing may be used to remove deposits and restore the smooth surface of the cathode and reactor components. This can be particularly effective if deposits have caused surface irregularities.

Automated Cleaning Systems: For larger industrial setups, automated cleaning systems that involve cleaning with rotating brushes or mechanical arms can be employed for more efficient and consistent cleaning. These systems can be programmed to clean on a regular schedule or in response to deposit buildup.

### Characterizations:

Electrodeposits are collected for upcoming physicochemical characterizations after each test is finished. The deposits are removed from the reactor and dried in a desiccator for 48 hours at room temperature. Scanning electron microscopy (SEM) is used to photograph the electrodeposits' surface and morphological characteristics. X-Ray diffraction (XRD) spectra are obtained at room temperature to determine the crystalline phases of the electrodeposits. The thermal stability of the electrodeposits and corresponding carbon content is investigated using thermogravimetric analysis (TGA).

### Example 2: Results and Advantages

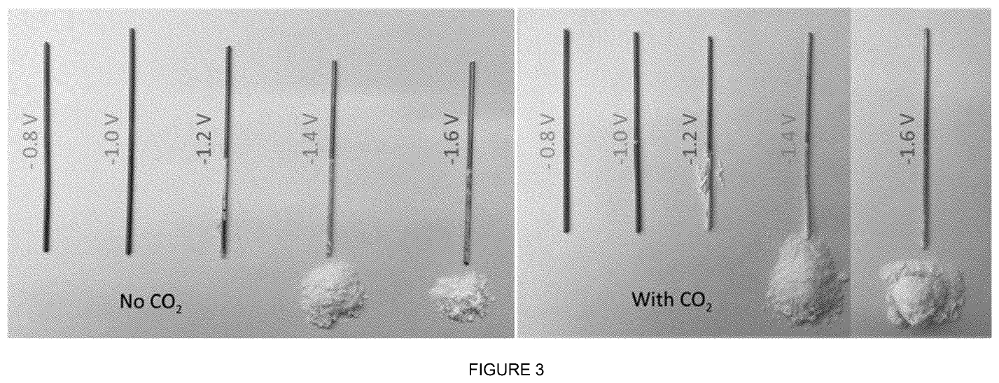

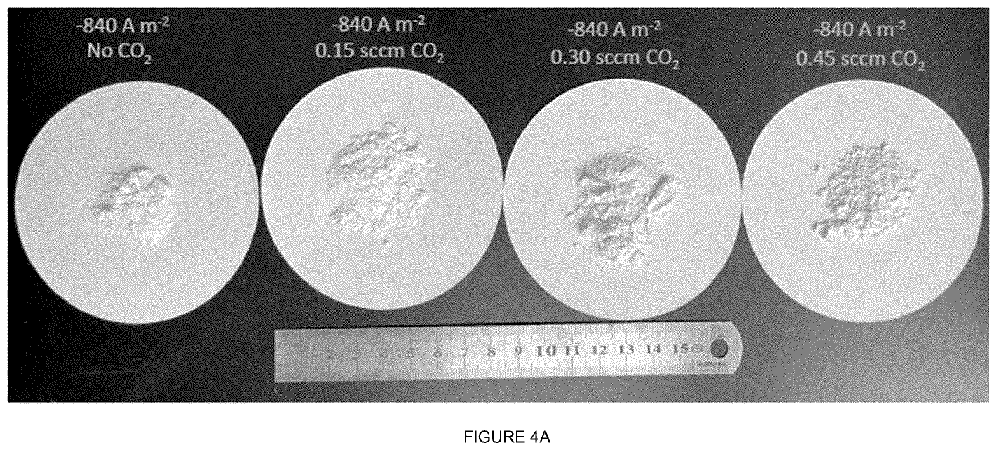

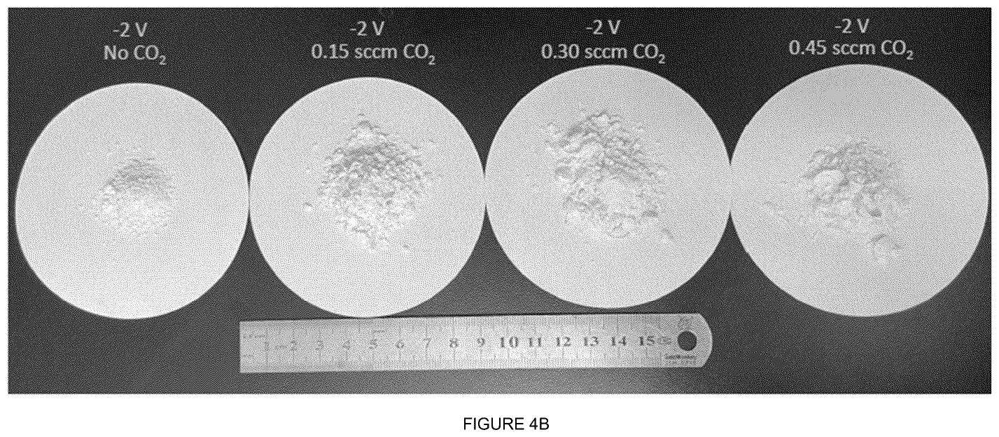

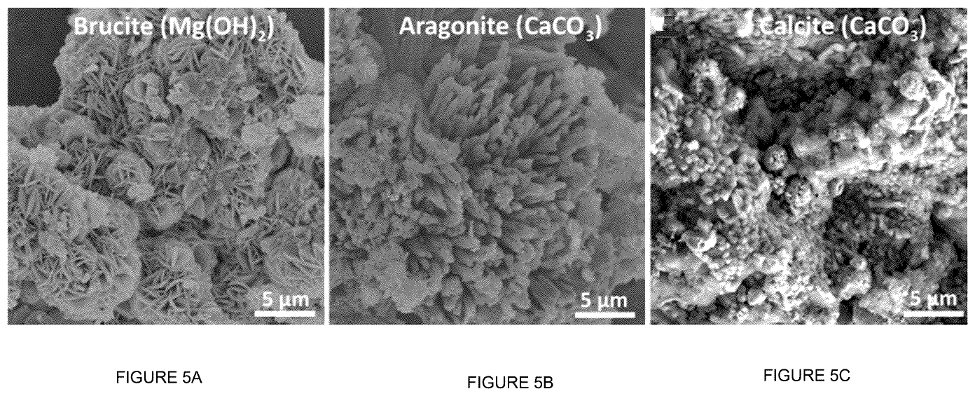

Working example 1: In a method for electrodeposition in seawater for the purpose of obtaining aggregates in the form of electrodeposits, an electric current with a density of −840 A/m² is applied to the cathode, where the cathode and anode have a surface area ratio of 1.5. The cathode and anode are positioned at a separation distance equal to the length of the anode. Simultaneously, CO₂ gas is introduced at a rate of 0.15 sccm (standard cubic centimeter per minute) at the bottom of a batch reactor with a volume of 2 liters, the reactor employing artificial seawater with an initial pH in the range of 8.3-8.5. The cathode's surface area is nearly 1.5 cm² per unit volume of the reactor. The electrodeposition process is sustained for a duration of 72 hours. The resulting electrodeposit has a mass of 355.67 mg/cm² and comprises aragonite (93.05%), calcite (6.81%), and brucite (0.11%), yielding a composite with 45.43% CaCO₃ and 54.57% Mg(OH)₂. The electrodeposit exhibits a density of 2.91 g/cc, and its aggregate size ranges from 0.01 to 5 mm. (FIG. 4A, −840 A/m²; 0.15 sccm CO₂).

Working example 2: In a method for electrodeposition in seawater for the purpose of obtaining aggregates in the form of electrodeposits, an electric current with a density of −840 A/m² is applied to the cathode, where the cathode and anode have a surface area ratio of 1.5. The cathode and anode are positioned at a separation distance equal to the length of the anode. Simultaneously, CO₂ gas is introduced at a rate of 0.30 sccm (standard cubic centimeter per minute) at the bottom of a batch reactor with a volume of 2 liters, the reactor employing artificial seawater with an initial pH in the range of 8.3-8.5. The cathode's surface area is nearly 1.5 cm² per unit volume of the reactor. The electrodeposition process is sustained for a duration of 72 hours. The resulting electrodeposit has a mass of 685.78 mg/cm² and comprises aragonite (65.89%), calcite (9.31%), and brucite (24.79%), yielding a composite with 52.01% CaCO₃ and 47.99% Mg(OH)₂. The electrodeposit exhibits a density of 2.75 g/cc, and its aggregate size ranges from 0.01 to 5 mm. (FIG. 4A, −840 A/m²; 0.30 sccm CO₂).

Working example 3: In a method for electrodeposition in seawater for the purpose of obtaining aggregates in the form of electrodeposits, an electric current with a density of −840 A/m² is applied to the cathode, where the cathode and anode have a surface area ratio of 1.5. The cathode and anode are positioned at a separation distance equal to the length of the anode. Simultaneously, CO₂ gas is introduced at a rate of 0.45 sccm (standard cubic centimeter per minute) at the bottom of a batch reactor with a volume of 2 liters, the reactor employing artificial seawater with an initial pH in the range of 8.3-8.5. The cathode's surface area is nearly 1.5 cm² per unit volume of the reactor. The electrodeposition process is sustained for a duration of 72 hours. The resulting electrodeposit has a mass of 430.70 mg/cm² and comprises aragonite (64.4%), calcite (26.41%), and brucite (9.18%), yielding a composite with 62.91% CaCO₃ and 37.09% Mg(OH)₂. The electrodeposit exhibits a density of 2.81 g/cc, and its aggregate size ranges from 0.01 to 5 mm. (FIG. 4A, −840 A/m²; 0.45 sccm CO₂).

Working Example 4: In a method for electrodeposition in seawater for the purpose of obtaining aggregates in the form of electrodeposits, an electric potential vs Ag/AgCl reference electrode of −2 V is applied to the cathode, where the cathode and anode have a surface area ratio of 1.5. The cathode and anode are positioned at a separation distance equal to the length of the anode. Simultaneously, CO₂ gas is introduced at a rate of 0.15 sccm (standard cubic centimeter per minute) at the bottom of a batch reactor with a volume of 2 liters, the reactor employing artificial seawater with an initial pH in the range of 8.3-8.5. The cathode's surface area is nearly 1.5 cm² per unit volume of the reactor. The electrodeposition process is sustained for a duration of 72 hours. The resulting electrodeposit has a mass of 637.43 mg/cm² and comprises aragonite (69.01%), calcite (3.93%), and brucite (27.06%), yielding a composite with 69.28% CaCO₃ and 30.71% Mg(OH)₂. The electrodeposit exhibits a density of 2.75 g/cc, and its aggregate size ranges from 0.01 to 5 mm. (FIG. 4B, −2V; 0.15 sccm CO₂)

Working Example 5: In a method for electrodeposition in seawater for the purpose of obtaining aggregates in the form of electrodeposits, an electric potential vs Ag/AgCl reference electrode of −2 V is applied to the cathode, where the cathode and anode have a surface area ratio of 1.5. The cathode and anode are positioned at a separation distance equal to the length of the anode. Simultaneously, CO₂ gas is introduced at a rate of 0.30 sccm (standard cubic centimeter per minute) at the bottom of a batch reactor with a volume of 2 liters, the reactor employing artificial seawater with an initial pH in the range of 8.3-8.5. The cathode's surface area is nearly 1.5 cm² per unit volume of the reactor. The electrodeposition process is sustained for a duration of 72 hours. The resulting electrodeposit has a mass of 654.68 mg/cm² and comprises aragonite (62.25%), calcite (20.93%), and brucite (16.81%), yielding a composite with 67.58% CaCO₃ and 32.41% Mg(OH)₂. The electrodeposit exhibits a density of 2.78 g/cc, and its aggregate size ranges from 0.01 to 5 mm. (FIG. 4B, −2V; 0.30 sccm CO₂)

Working Example 6: In a method for electrodeposition in seawater for the purpose of obtaining aggregates in the form of electrodeposits, an electric potential vs Ag/AgCl reference electrode of −2 V is applied to the cathode, where the cathode and anode have a surface area ratio of 1.5. The cathode and anode are positioned at a separation distance equal to the length of the anode. Simultaneously, CO₂ gas is introduced at a rate of 0.15 sccm (standard cubic centimeter per minute) at the bottom of a batch reactor with a volume of 2 liters, the reactor employing artificial seawater with an initial pH in the range of 8.3-8.5. The cathode's surface area is nearly 1.5 cm² per unit volume of the reactor. The electrodeposition process is sustained for a duration of 72 hours. The resulting electrodeposit has a mass of 589.30 mg/cm² and comprises aragonite (41.95%), calcite (7.64%), and brucite (50.41%), yielding a composite with 43.92% CaCO₃ and 56.08% Mg(OH)₂. The electrodeposit exhibits a density of 2.61 g/cc, and its aggregate size ranges from 0.01 to 5 mm. (FIG. 4B, −2V; 0.45 sccm CO₂)

TABLE 1
Summary of working examples with experimental conditions and results

| | | | | | |
|---|---|---|---|---|---|
| Working | Working | Working | Working | Working | Working |
| example 1 | example 2 | example 3 | example 4 | example 5 | example 6 |

Experimental parameters:

| Cathode | Cylinder, | | Cylinder, | | Cylinder, | | Cylinder, | | Cylinder, | | Cylinder, | |
|---|---|---|---|---|---|---|---|---|---|---|---|---|
| geometry | Outer | | Outer | | Outer | | Outer | | Outer | | Outer | |
| | diameter | | diameter | | diameter | | diameter | | diameter | | diameter | |
| | 2 mm, active | | 2 mm, active | | 2 mm, active | | 2 mm, active | | 2 mm, active | | 2 mm, active | |
| | length 4.5 cm | | length 4.5 cm | | length 4.5 cm | | length 4.5 cm | | length 4.5 cm | | length 4.5 cm | |
| Anode geometry | Cylinder, | | Cylinder, | | Cylinder, | | Cylinder, | | Cylinder, | | Cylinder, | |
| | outer | | outer | | outer | | outer | | outer | | outer | |
| | diameter | | diameter | | diameter | | diameter | | diameter | | diameter | |
| | 0.78 mm, active | | 0.78 mm, active | | 0.78 mm, active | | 0.78 mm, active | | 0.78 mm, active | | 0.78 mm, active | |
| | length 7.5 cm | | length 7.5 cm | | length 7.5 cm | | length 7.5 cm | | length 7.5 cm | | length 7.5 cm | |
| Cathode/anode | 1.5 | | 1.5 | | 1.5 | | 1.5 | | 1.5 | | 1.5 | |
| surface area | | | | | | | | | | | | |
| ratio | | | | | | | | | | | | |
| Active surface | 0.14 | m² | 0.14 | m² | 0.14 | m² | 0.14 | m² | 0.14 | m² | 0.14 | m² |
| of cathode per | | | | | | | | | | | | |
| m³ of AS3 | | | | | | | | | | | | |
| Reactor volume | 2.5 | liters | 2.5 | liters | 2.5 | liters | 2.5 | liters | 2.5 | liters | 2.5 | liters |
| Volume of AS3 | 2 | liters | 2 | liters | 2 | liters | 2 | liters | 2 | liters | 2 | liters |
| Seawater | Artificial | | Artificial | | Artificial | | Artificial | | Artificial | | Artificial | |
| composition | seawater | | seawater | | seawater | | seawater | | seawater | | seawater | |
| CO₂ | Carbon | | Carbon | | Carbon | | Carbon | | Carbon | | Carbon | |
| composition | dioxide | | dioxide | | dioxide | | dioxide | | dioxide | | dioxide | |
| | research | | research | | research | | research | | research | | research | |
| | 99.999% | | 99.999% | | 99.999% | | 99.999% | | 99.999% | | 99.999% | |
| CO₂ flowrate | 0.15 sccm | | 0.30 sccm | | 0.45 sccm | | 0.15 sccm | | 0.30 sccm | | 0.45 sccm | |
| | (standard | | (standard | | (standard | | (standard | | (standard | | (standard | |
| | cubic | | cubic | | cubic | | cubic | | cubic | | cubic | |
| | centimeter | | centimeter | | centimeter | | centimeter | | centimeter | | centimeter | |
| | per minute) | | per minute) | | per minute) | | per minute) | | per minute) | | per minute) | |
| | in 2 liters of | | in 2 liters of | | in 2 liters of | | in 2 liters of | | in 2 liters of | | in 2 liters of | |
| | AS3 | | AS3 | | AS3 | | AS3 | | AS3 | | AS3 | |
| Applied current | 840 | A/m2 | 840 | A/m2 | 840 | A/m2 | | | | | | |
| Applied voltage | | | | | | | 2 | V | 2 | V | 2 | V |
| Time of electric | 3 days per 2 | | 3 days per 2 | | 3 days per 2 | | 3 days per | | 3 days per | | 3 days per | |
| treatment | liters of AS3 | | liters of AS3 | | liters of AS3 | | 2 liters of | | 2 liters of | | 2 liters of | |
| | | | | | | | AS3 | | AS3 | | AS3 | |
| pH of AS3 | 8.3-8.5 | | 8.3-8.5 | | 8.3-8.5 | | 8.3-8.5 | | 8.3-8.5 | | 8.3-8.5 | |
| Temperature | 21-25° | C. | 21-25° | C. | 21-25° | C. | 21-25° | C. | 21-25° | C. | 21-25° | C. |

Results:

| Total mass of | 355.67 | | 685.78 | | 430.70 | | 637.43 | | 654.68 | | 589.30 | |
|---|---|---|---|---|---|---|---|---|---|---|---|---|
| the | Or | | Or | | Or | | Or | | Or | | Or | |
| electrodeposits | 3.56 | | 6.86 | | 4.31 | | 6.37 | | 6.55 | | 5.89 | |
| [mg cm⁻²] | | | | | | | | | | | | |
| Or | | | | | | | | | | | | |
| [kg m⁻²] | | | | | | | | | | | | |
| Composition of | Aragonite | | Aragonite | | Aragonite | | Aragonite | | Aragonite | | Aragonite | |
| electrodeposits | 93.05%, | | 65.89%, | | 64.4%, | | 69.01%, | | 62.25%, | | 41.95%, | |
| | Calcite | | Calcite | | Calcite | | Calcite | | Calcite | | Calcite | |
| | 6.81%, | | 9.31%, | | 26.41%, | | 3.93%, | | 20.93%, | | 7.64%, | |
| | Brucite | | Brucite | | Brucite | | Brucite | | Brucite | | Brucite | |
| | 0.11% | | 24.79% | | 9.18% | | 27.06% | | 16.81% | | 50.41% | |
| CaCO₃% | 45.43% | | 52.01% | | 62.91% | | 69.28% | | 67.58% | | 43.92% | |
| Mg(OH)₂% | 54.57% | | 47.99% | | 37.09% | | 30.71% | | 32.41% | | 56.08% | |
| Size of the | 0.01-5 | mm | 0.01-5 | mm | 0.01-5 | mm | 0.01-5 | mm | 0.01-5 | mm | 0.01-5 | mm |
| electrodeposits | | | | | | | | | | | | |
| Density of | 2.91 | g/cc | 2.75 | g/cc | 2.81 | g/cc | 2.75 | g/cc | 2.78 | g/cc | 2.61 | g/cc |
| electrodeposits | | | | | | | | | | | | |
| mixture | | | | | | | | | | | | |
| Energy | 127.79 | | 125.18 | | 123.37 | | 113.84 | | 87.75 | | 96.41 | |
| consumption | | | | | | | | | | | | |
| [kJ] | | | | | | | | | | | | |

### Non-working Example 1

Applying a current density of −840 mA/cm² without injecting any external CO₂ produces lesser yield (170.84 mg/cm²) with higher energy consumption (311.63 kJ) as compared to the product yield achieved with CO₂ injection (>350 mg/cm²) with similar experimental parameters and conditions and lower energy (127.79 kJ). The magnitude of current density described leads to an elevated production rate of OH-ions, resulting in a high interfacial pH near the cathode. However, due to the limited availability of carbonate and bicarbonate ions in seawater (in case of absence of external CO₂ injection) compared to calcium and magnesium, coupled with the concurrent generation of H⁺ at the anode, both OH and H⁺ ions can engage in neutralization reactions independently of OH-participation in precipitation reactions results in lower production yield. This underscores the significance of carbonate ion concentrations in achieving the solubility precipitation index of CaCO₃ and increase the yield as well as CO₂ sequestration in CaCO₃. (FIG. 4A, −840 A/m²; No CO₂).

### Non-Working Example 2

Applying a voltage of −2 V vs Ag/AgCl reference electrode without injecting any external CO₂ produces lesser yield (217.47 mg/cm²) with equal energy consumption (139.63 kJ) as compared to the product yield achieved with CO₂ injection (>550 mg/cm²) with similar experimental parameters and conditions and energy consumption (˜100 kJ). This is again due to the reason of sufficient production of OH ions but limited availability of carbonate ions. Moreover, as the electrochemical reactions that produce OH-ions are voltage dependent, a lower electrochemical voltage can provide a higher yield with less energy consumption when there is no CO₂ injection. Applying a voltage of −2 V (vs Ag/AgCl reference electrode) without introducing external CO₂ results in a lower yield (217.47 mg/cm²) with equivalent energy consumption (139.63 kJ) compared to the product yield achieved through CO₂ injection (>550 mg/cm²) under similar experimental parameters and conditions, with energy consumption approximately around 100 kJ. This disparity arises from the ample production of OH-ions at this voltage but limited availability of carbonate ions in the absence of CO₂ injection. Furthermore, given that the electrochemical reactions generating OH-ions are voltage-dependent, a lower electrochemical voltage (e.g., −1.4 V) can yield higher outputs with reduced energy consumption as compared to −2 V when external CO₂ is not introduced. (FIG. 4B, −2V; No CO₂).

### Non-Working Example 3

Applying a current density of −1680 A/m² and injecting a CO₂ concentration of 0.30 scm CO₂ results in a lower product yield (332.9 mg/cm²) compared to −840 mA/cm² (685.58 mg/cm²) while consuming significantly more energy. This outcome underscores the insight that merely augmenting the rate of OH-generation at the cathode, coupled with the availability of calcium and carbonates, does not necessarily enhance the precipitation rate. The observed limitation arises from the dynamics of a membrane-free, one-pot batch reactor, where increasing current density leads to heightened mass transfer of ions, cross talk of ions, and side reactions, thereby impeding precipitation. This observation suggests the utilization of membranes in the reactor design.

Non-working example 4: Applying a less negative potential such as-1.4 V vs Ag/AgCl and injecting a concentration of CO₂ (0.15 sccm CO₂) produces lesser yield of the product after CO₂ injection (195.05 mg/cm² as compared to 322.86 mg/cm²) due to decrease in pH and insufficient availability of OH ions to participate in precipitation reactions. The result directs towards a shift in potential required to produce a higher yield with CO₂ injection as there needs extra moles of OH-ions to neutralize the acidity introduced by CO₂. Hence, achieving an optimal equilibrium between the rate of OH-ion production at the cathode and the concentration of carbonates/CO₂ is essential for achieving a higher product yield and enhanced CO₂ sequestration.

TABLE 2
Summary of non-working examples

| | | | |
|---|---|---|---|
| Non-Working | Non-Working | Non-Working | Non-Working |
| example 1 | example 2 | example 3 | example 4 |

Experimental parameters:

| Cathode geometry | Cylinder, Outer | | Cylinder, Outer | | Cylinder, Outer | | Cylinder, Outer | |
|---|---|---|---|---|---|---|---|---|
| | diameter 2 mm, | | diameter 2 mm, | | diameter 2 mm, | | diameter 2 mm, | |
| | active length | | active length | | active length | | active length | |
| | 4.5 cm | | 4.5 cm | | 4.5 cm | | 4.5 cm | |
| Anode geometry | Cylinder, outer | | Cylinder, outer | | Cylinder, outer | | Cylinder, outer | |
| | diameter 0.78 mm, | | diameter 0.78 mm, | | diameter 0.78 mm, | | diameter 0.78 mm, | |
| | active length 7.5 cm | | active length 7.5 cm | | active length 7.5 cm | | active length 7.5 cm | |
| Cathode/anode surface | 1.5 | | 1.5 | | 1.5 | | 1.5 | |
| area ratio [SAR] | | | | | | | | |
| Active surface of | 0.14 | m² | 0.14 | m² | 0.14 | m² | 0.14 | m² |
| cathode per m³ of AS3 | | | | | | | | |
| Reactor volume [CR2V] | 2.5 | liters | 2.5 | liters | 2.5 | liters | 2.5 | liters |
| Volume of AS3 | 2 | liters | 2 | liters | 2 | liters | 2 | liters |
| Seawater composition | Artificial seawater | | Artificial seawater | | Artificial seawater | | Artificial seawater | |
| [AS3] | | | | | | | | |
| CO₂ composition [C- | Carbon dioxide | | Carbon dioxide | | Carbon dioxide | | Carbon dioxide | |
| Gas] | research 99.999% | | research 99.999% | | research 99.999% | | research 99.999% | |
| CO₂ inlet flowrate, [CGI] | 0, No CO₂ | | 0, No CO₂ | | 0.30 sccm | | 0.15 sccm | |
| | | | | | (standard cubic | | (standard cubic | |
| | | | | | centimeter per | | centimeter per | |
| | | | | | minute) in 2 | | minute) in 2 | |
| | | | | | liters of AS3 | | liters of AS3 | |
| Applied current [mA] | −240 | mA | | | −240 | mA | | |
| Current density [A/m²] | −840 | A/m² | | | −1680 | A/m² | | |
| Applied voltage [V] | | | −2 | V | | | −1.4 | V |
| Time of electric | 3 days per 2 | | 3 days per 2 | | 3 days per 2 | | 3 days per 2 | |
| treatment | liters of AS3 | | liters of AS3 | | liters of AS3 | | liters of AS3 | |
| pH of AS3 | 8.3-8.5 | | 8.3-8.5 | | 8.3-8.5 | | 8.3-8.5 | |
| Temperature | 21-25° | C. | 21-25° | C. | 21-25° | C. | 21-25° | C. |
| Total mass of the | 170.84 | | 217.47 | | 332.9 | | 195.05 | |
| electrodeposits | Or | | Or | | Or | | Or | |
| [mg cm⁻²] Or | 1.70 | | 2.17 | | 3.33 | | 1.95 | |
| [kg m⁻²] | | | | | | | | |
| Energy consumption | 311.63 | | 139.63 | | 308.49 | | 1.74 | |
| [kJ] | | | | | | | | |

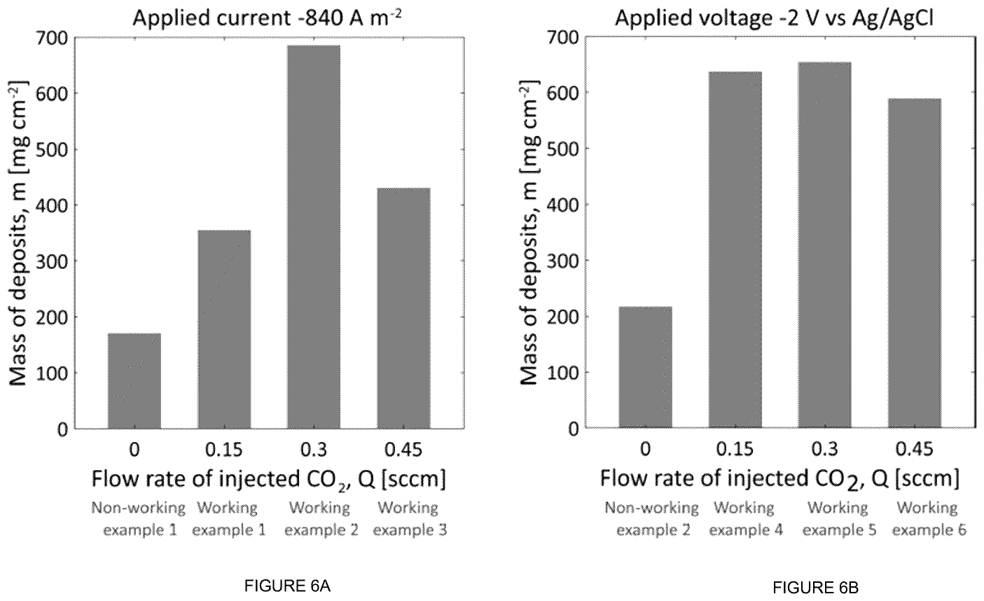

FIG. 6 shows the relationship between the total mass of electrodeposited aggregates and the injected CO₂ flow rate at an applied electrochemical current (−840 A/m², FIG. 6A) and voltage (−2 V vs Ag/AgCl, FIG. 6B). As the volume (concentration) of injected CO₂ rises from no CO₂ to a flow rate of 0.45 sccm (standard cubic centimeters per minute) in 2-liter seawater (equivalent to 1944 scc or 86.78 mmol per 2-liter), FIG. 6A and B indicates an increase in the total yield of aggregates after external CO₂ injection. This growth is attributed to the higher availability of carbonate ions following CO₂ injection and an increased precipitation rate under these specific current and potential conditions.

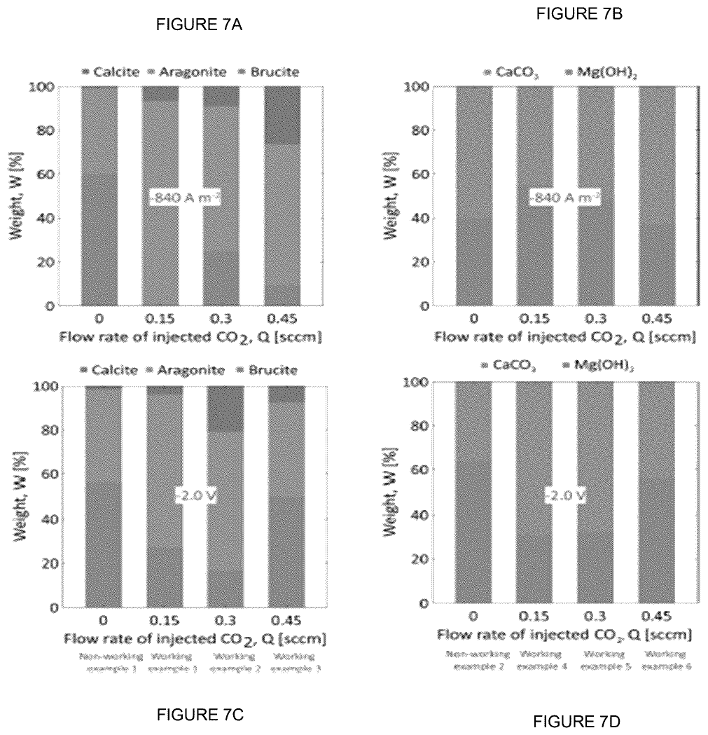

FIG. 7A illustrates the percentage weight of polymorphs determined by XRD, while FIG. 7B depicts the percentage weight of CaCO₃ and Mg(OH)₂ estimated from TGA at an applied current of −240 mA or −840 mA/cm². These figures represent the impact of injected CO₂ flow rate in a 2-liter vessel. In FIG. 7A, at a current of −840 A/m², there is a substantial increase in the weight percentage of aragonite and calcite, along with a decrease in brucite growth. This suggests that the injected CO₂ is stored as CaCO₃.

FIG. 7B, utilizing TGA, reveals an increased percentage of CaCO₃ and as well as the presence of undetectable amorphous Mg(OH)₂ by XRD. It also indicates that a higher CO₂ flow rate, allowing a greater CO₂ concentration near the cathode, is unfavorable to precipitation of solids. This is due to a pH drop caused by the elevated CO₂ concentration, hindering aggregate growth. The figures highlight the interdependence between the OH⁻ ion production rate near the cathode (linked to magnitude of applied current) and the CO₂ injection flow rate or concentration over time.

Similarly, FIG. 7C illustrates the percentage weight of polymorphs determined by XRD, while FIG. 7D depicts the percentage weight of CaCO₃ and Mg(OH)₂ estimated from TGA at an applied voltage of −2 V (vs Ag/AgCl). These figures again represent the impact of injected CO₂ flow rate in a 2-liter vessel. In FIG. 7C, at a voltage of −2 V, there's a substantial increase in the weight percentage of aragonite and calcite, along with a decrease in brucite growth. This suggests that the injected CO₂ is stored as CaCO₃. FIG. 7D, utilizing TGA, reveals an increased percentage of CaCO₃ and decreased Mg(OH)₂. It also indicates that a higher CO₂ flow rate, allowing a greater CO₂ concentration near the cathode, is unfavorable to CaCO₃ formation. This is due to a pH drop caused by the elevated CO₂ concentration, hindering aggregate growth. The figures highlight the interdependence between the OH-ion production rate near the cathode (linked to magnitude of applied voltage) and the CO₂ injection flow rate or concentration over time.

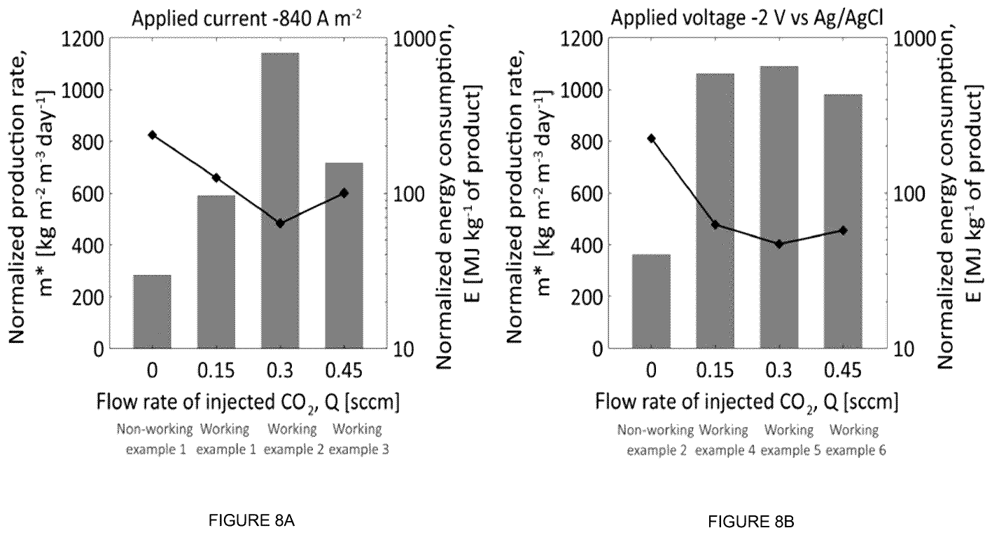

FIGS. 8A and 8B illustrate the production rate (left y-axis) and energy consumption (right y-axis) in relation to the flow rate of injected CO₂, with a constant current of −840 mA/cm² and an applied voltage of −2.0 V (vs Ag/AgCl). The normalized production rate is quantified in kg·m⁻²·m⁻³ per day, denoting the mass of electrodeposits achievable from processing 1 m² of cathode surface area using 1 m³ of seawater daily. Similarly, the normalized energy consumption is expressed in MJ·kg⁻¹, reflecting the energy required to produce 1 kg of electrodeposits. The laboratory findings highlight an optimal balance between energy consumption (attributed to electric current and voltage application) and production rate in response to CO₂ injection. Moreover, the observed increase in production rate resulting from carbon sequestration through injected CO₂ contributes to a reduction in energy consumption per unit of the produced aggregates.

### Discussion of the Results and Advantages

An optimum yield at a higher volume of injected CO₂ requires a balance in pH because of simultaneous generation of alkalinity (due to voltage/current) and acidity (due to CO₂). It is evident that CO₂ injection leads to an increase in the total electrodeposits yield, however, needs a higher overpotential to fulfill the upraised requirement of OH⁻ raised due to drop in pH caused by CO₂.

pH trend depicts that the generation or consumption of both H⁺ and OH-during the electrochemical conversion process of CO₂ is influenced by the voltage/current, which in turn impacts the precipitation reactions taking place at the cathode. On the other hand, the applied voltage helps generate protons (H⁺) at the anode, where oxidation events occur. The pH of the seawater solution near the anode may decrease because of these protons' additional contribution to the acidification of the solution. Controlling the pH facilitates the subsequent mineral precipitation process and improves the electrochemical system's overall stability.

The electrodeposition process allows tailoring an electrodeposit mixture of CaCO₃ and Mg(OH)₂ in a range of percentage weight of 50:50, 30:70 and 10:90. The carbonates content in mixture of electrodeposits highlights the efficacy of the carbon-negative electrodeposition approach in sequestering carbon dioxide from the atmosphere.

It is possible to fine-tune variables including carbon dioxide input, applied electrochemical potential, and reactor design to regulate crucial electrodeposited mineral properties. Aspects including morphology, size, content, mineral structure, yield, and carbon sequestration capability are included in this.

The type of polymorph is a function of the Mg: Ca ratio in AS1 and temperature. The possible polymorphs of CaCO₃ to precipitate are calcite, aragonite, and vaterite in order of their decreasing thermodynamic stability. We have not observed vaterite formation on a lab scale so far. It is possible to form vaterite under certain conditions (low temperature, pH>9) but even if it forms, it can transform aragonite within 60 minutes when exposed to a temperature of 60° C. or more and it can change into calcite over 24 hours when kept at room temperature. (Geochimica et Cosmochimica Acta, Vol. 67, No. 9, pp. 1659-1666, 2003, Geology; January 1997; v. 25; no. 1; p. 85-87) [9].

To ensure and maintain a high calcium content in precipitated aggregates results show that maintaining the pH within the range of 9.5 to 10 is advisable, as exceeding a pH of 10 may induce preferential precipitation of magnesium hydroxide (Mg(OH)₂). Calcium hydroxide (Ca(OH)₂) does not precipitate under these conditions as it remains undersaturated in the pH range below 12.

### Core Advantages of the Invention:

Carbon sequestration through electrodeposition: One of the primary advantages is the substantial reduction of carbon emissions in the cement and concrete industries. The proposed technique actively absorbs the dissolved carbon dioxide during the electrodeposition process, contributing to carbon sequestration. By harnessing ocean and sea waters to electrodeposit calcium and magnesium-based minerals while injecting carbon dioxide gas, the process actively absorbs carbon dioxide in the form of mineral carbonates. This dual functionality addresses both the production of construction materials and the removal of carbon dioxide from the atmosphere. This addresses a pressing global challenge of mitigating climate change by directly reducing the carbon footprint associated with construction materials.

Utilization of abundant oceanic mineral resources: By capitalizing on the substantial mineral resources found in ocean and sea waters, the invention taps into an abundant and naturally available source of calcium, magnesium, and bicarbonate ions. Electrodeposition allows the conversion of calcium present in seawater into calcium carbonates and magnesium in the form of hydroxides which can also be converted into magnesium carbonates later step by reacting with more carbon-dioxide. This approach reduces the environmental impact linked to conventional mining for cement and concrete production raw materials, offering a sustainable alternative for aggregates production that can substitute traditional mined resources in the industry.

Sustainable construction materials: The electrodeposition technique offers a sustainable alternative for manufacturing construction materials. By cultivating minerals from oceanic resources, the approach minimizes the ecological footprint of the cement and concrete industries. This aligns with the growing demand for environmentally friendly and sustainable practices in the construction sector. The technique leverages the interaction of hydroxide ions generated in the water-splitting electrode with the naturally occurring calcium and magnesium ions in ocean and sea waters and externally injected carbon-dioxide allows the availability of sufficient carbonate ions. This enhances mineral deposition rates, making the manufacturing process more efficient and potentially cost-effective.

Customization of mineral attributes: The innovation allows for the tailoring of central attributes of electrodeposited minerals, including their morphology, size, composition, mineral form, yield, and carbon sequestration potential. This level of customization provides flexibility in adapting the construction materials to specific requirements, ensuring their suitability for various applications in the cement and concrete industries.

Laboratory-validated feasibility: The experimental laboratory tests conducted in custom-designed electrochemical cells confirm the feasibility of the proposed approach. This scientific validation establishes a foundation for further development and implementation, assuring that the technique is not just theoretical but can be practically applied on a larger scale.

Scalable implementation: The findings pave the way for scalable implementation of the proposed approach, indicating that it has the potential to be adopted on a larger, industrial scale. This scalability is crucial for addressing the significant demands of the construction industry while maintaining sustainability.

Comprehensive solution to industry challenges: The proposed innovation offers a comprehensive solution to the pressing global challenges faced by the cement and concrete industries. By addressing both carbon emissions and the sustainable sourcing of construction materials, it represents a holistic approach that aligns with the broader goals of sustainable development and environmental stewardship.

### LIST OF REFERENCES

1. U.S. Pat. No. 11,413,578
2. WO 2022/178125
3. WO 2007/140544
4. US20100084283
5. EP 1 830 945
6. U.S. Pat. No. 11,465,925
7. Zhang et al., Direct Electrochemical Seawater Splitting for Green Hydrogen and Artificial Reefs, ACS Applied Energy Materials, 6 (14): 7636-7642, 2023
8. Carre et al., Electrochemical calcareous deposition in seawater. A review, Environmental Chemistry Letters, 18:1193-1208, 2020
9. Geochimica et Cosmochimica Acta, Vol. 67, No. 9, pp. 1659-1666, 2003, Geology; January 1997; v. 25; no. 1; p. 85-87

1. Method to produce calcium rich-based aggregates, said method comprising the following steps:
a) Filter an aqueous salty solution AS1 to produce an aqueous salty solution AS2 free of organic debris or pollutants;
b) Bring the aqueous salty solution AS2 at a temperature from 18 to 29° C. and at a pH from 7.1 to 9, in a conditioning reactor CR1 to produce an aqueous salty solution AS3;
c) Bring the aqueous salty solution AS3 from CR1 to a continuous reactor CR2 equipped with an electroactive substrate comprising at least one cathode and at least one anode connected to an electrical DC supply, wherein the flux of AS3 (FRAS3) in CR2 is kept at a velocity or displacement speed VAS3 located from 0.01 m/s to 5 m/s;
d) Inject in CR2 a flux of a gas mixture containing CO₂ (C-gas) in contact with the flux of the aqueous solution AS3;
e) Apply to the flux of the CO₂-enriched aqueous solution AS3 a constant DC current ranging from 1 A/m² to 5000 A/m², the m² representing the deployed surface of the electrodes in contact with AS3, or a voltage ranging from 0.5 V to 20.0 V, to the electrodes;
f) Recover the calcium rich-based aggregates deposited on the electroactive substrate and/or on the bottom of CR2.

2. Method according to claim 1, wherein the aqueous salty solution AS2 is brought in step b) at a temperature from 20° C. to 25° C. and at a pH from 8.0 to 8.4, in CR1.

3. Method according to claim 1, wherein the continuous reactor CR2 of step c) comprises at least two compartments each comprising at least one cathode or at least one anode.

4. Method according to claim 1, wherein the C-gas of step d) is re-circulated to be re-injected into CR2.

5. Method according to claim 1, wherein the volume % of CO₂ injected in the continuous reactor CR2 in step d) is 0.05-10 volume % per hour.

6. Method according to claim 1, wherein the DC current ranges from 5 A/m² to 1000 A/m².

7. Method according to claim 1, wherein the voltage ranges from 0.8 V to 10.0 V volts.

8. Method according to claim 1, wherein the calcium rich-based aggregates are produced with a CaCO₃ content from 20% to 90%.

9. Method according to claim 1; wherein the calcium rich-based aggregates are produced with an average size from 0.1 mm to 15 mm.
